(19) United States
(12) Patent Application Publication
(10) Pub. No.: US 2011/0084473 A1
(43) Pub. Date: Apr. 14, 2011

(54) IDENTIFICATION DOCUMENT WITH IMPROVED ANTI-TAMPER SECURITY; METHOD OF PRODUCING AN IDENTIFICATION DOCUMENT WHICH FACILITATES DETECTION OF TAMPERING WITH THE IDENTIFICATION DOCUMENT

(75) Inventors: Ronny Walther, Roding (DE); Michael Wanjek, Nittenau (DE)

(73) Assignee: Mühlbauer AG, Roding (DE)

(21) Appl. No.: 12/892,356

(22) Filed: Sep. 28, 2010

(30) Foreign Application Priority Data
Oct. 8, 2009 (DE) DE102009048 805.7

(51) Int. Cl. B42D 15/00; B32B 38/00; B32B 37/02

(52) U.S. Cl. 283/74; 156/257

(57) ABSTRACT

An identification document has a substrate and a laminating film bonded to the substrate. The surface of the substrate facing the laminating film bears first text, numeric and/or image data detectable with the naked eye at least when illuminated by daylight and a first zone with a fluorescent substance. Under excitation with light in a specific wavelength range the substance fluoresces in colour in a manner detectable with the naked eye. The laminating film has a second zone which bears second text, numeric and/or image data. The first zone of the surface of the substrate and the second zone of the laminating film overlap one another at least partially.

### CROSS-REFERENCE TO RELATED APPLICATIONS

This application claims the benefit of the priority date of German Patent Application No. DE 10 2009 048 805.7, “Identification document with improved anti-tamper security; method of producing an identification document which facilitates detection of tampering with the identification document,” filed Oct. 8, 2009.

### BACKGROUND

An identification document with improved anti-tamper security is described herein. Also described is a method of producing an identification document which facilitates detection of tampering with the identification document. In particular it is intended to make it easier to detect or more difficult to effect tampering with an identification document or counterfeiting of an identification document.

Identification documents described herein are understood to include passports, identity cards, driving licences, visas, electronic purse cards, credit cards, labels, access passes, etc..

A wide range of security elements are known from the prior art, for example document D1 (DE 10 2008 036 402 B3) describes a gonioluminescent security element and a method for the production thereof. The security element comprises a first element and a second element at least partially overlapping the first element. The first element comprises first luminescent means. The second element faces towards the observation side of the security element and exhibits orientation-dependent transmittance and/or reflectance, such that an optical change may be perceived on observation during excitation of luminescence of the luminescent means as a function of orientation of the observation through the second element.

However, identification documents are these days often manufac- tured in a centralised manner apart from personalisation data and then personalised in a decentralised manner, for example at registration centres or by authorities or companies which are authorised to issue such value and security documents. On personalisation, text, numeric and/or image data individually identifying the respective holder of the value and security document are entered in the identification document. These data comprise for example name and address of the holder, date of birth, place of birth, a photograph of the holder, biometric data relating to the holder, etc. These text, numeric and/or image data are then conventionally immediately readable by an observer.

Problem

Such identification documents are subject to ever more stringent requirements regarding anti-tamper security and tamper detectability. These identification documents also need to be inexpensive, quick and reliable to produce.

Proposed solution

The solution proposed to this problem is an identification document with a substrate comprising a surface and a laminating film bonded to the surface of the substrate. The surface of the substrate facing the laminating film bears first text, numeric and/or image data detectable with the naked eye at least when illuminated by daylight and a first zone with a fluorescent substance. Under excitation with light in a specific wavelength range the substance fluoresces in colour in a manner detectable with the naked eye. The laminating film has a second zone which bears second text, numeric and/or image data. The second text, numeric and/or image data are engraved to such a depth into a layer of the laminating film which blocks or at least attenuates light in a specific wavelength range that the blocking or at least attenuating effect of said layer is reduced to such an extent that the second text, numeric and/or image data are detectable with the naked eye when illuminated with light in a wavelength range which excites the fluorescent substance of the first zone and causes it to fluoresce. The first zone of the surface of the substrate and the second zone of the laminating film overlap one another at least partially.

Configurations and characteristics

Tampering with the identification document or counterfeiting of an identification document may be more easily detected by these measures, or are more difficult to effect, since both the laminating film (the laminate) and the substrate bear data which are relevant to the identification document. Furthermore, the laminate forms an integral unit with the substrate.

To personalise the identification document a defined area is printed on the substrate for example with fluorescent ink. This fluorescent ink on the substrate has the property of being at least virtually invisible when illuminated with daylight but of fluorescing in colour when excited by light in a specific wavelength range.

Since at least some of the information (data) relevant to the identification document is also present in the laminate, this part of the identification document is also uniquely personalised. In this case, at least some of the information borne by the substrate is also assigned to the laminate either in duplicate or as just a single copy. This makes counterfeiting of or tampering with the laminate or the substrate of the identification document readily detectable by performing a comparison between the information contained on or in the substrate and the information contained on or in the laminate. The laminate thus acts, with the information (data) contained therein and relevant to the identification document, as a security film which gives the identification document added security.

The depth of engraving may be varied continuously or in discrete steps, for example by modifying the operating parameters of a laser used for engraving, and may amount for example to approx. 5% to approx. 35% of the thickness of this layer. The above details should be understood as examples; in specific applications the removed regions of the laminating film, i.e. the engraving depth, may also deviate from these values.

Overall, the engraving depth in the layer is at any rate such that on the one hand the data are at least virtually invisible relative to their surroundings on the surface of the laminating film when illuminated with daylight and on the other hand the data are readily detectable with the naked eye when illuminated with light in the fluorescence-exciting wavelength range.

The second text, numeric and/or image data located in the second zone may be engraved as a greyscale image into the layer of the laminating film which blocks or at least attenuates light in a specific wavelength range.

Both the substrate and the laminating film thus bear text, numeric and/or image data relevant to the identification document and together form an integral unit.

The laminating film may comprise an additional coating on one or both surfaces. This additional coating may for example be a metal mirror or a metallising layer (for example of aluminium). The laminating film is either transparent or opaque (at least in places). The engraving shapes the topology of the laminating film and, if present, the additional coating. This ensures the different transmittance of the laminating film for the fluorescent light.

In addition to the first data detectable in daylight with the naked eye, data invisible to the naked eye may additionally be applied to the substrate. These may be data which are comparable to the first data and are applied with a printing process/a printing ink, such that they are visible in a wavelength range deviating from the UV range (for example in the IR range).

In addition, a method of producing an identification document with a substrate and a laminating film is proposed which has the following steps: (i) providing the substrate, (ii) printing the substrate with first text, numeric and/or image data detectable with the naked eye at least when illuminated by daylight, (iii) coating the substrate in a first zone with a fluorescent substance, which fluoresces in colour in a manner detectable with the naked eye when excited with light in a specific wavelength range, (iv) providing a laminating film, (v) engraving second text, numeric and/or image data into a second zone of the laminating film, wherein the text, numeric and/or image data engraved into the second zone are engraved to such a depth into a layer of the laminating film which blocks or at least attenuates light in a specific wavelength range that the blocking or at least attenuating effect of the layer is reduced to such an extent that the second text, numeric and/or image data are detectable with the naked eye when illuminated with light of a wavelength range which excites the fluorescent substance of the first zone and causes it to fluoresce, and (vi) applying the laminating film onto the substrate by lamination, such that the first zone of the substrate and the second zone of the laminating film overlap one another at least partially.

The above-stated steps may be performed in different orders: On the one hand the stated order may be selected. On the other hand steps (ii) and (iii) may also be switched round. Additionally or instead, steps (v) and (vi) may also be switched round.

The first zone with the fluorescent substance may be such that it is at least virtually invisible relative to its surroundings on the substrate when illuminated by daylight.

The specific wavelength range of the layer which blocks or at least attenuates light may correspond at least partially to the wavelength range in which the fluorescent substance of the first zone fluoresces in colour in a manner detectable with the naked eye.

The second text, numeric and/or image data engraved into the second zone may be engraved into the layer of the laminating film which blocks or at least attenuates light in a specific wavelength range merely to such a shallow depth that they are at least virtually invisible relative to their surroundings on the laminating film when illuminated with daylight.

The second text, numeric and/or image data engraved into the second zone may be engraved as a greyscale image into the layer of the laminating film which blocks or at least attenuates light in a specific wavelength range. Depending on how deeply a point is engraved into the layer in the second zone, the fluorescent substance becomes visible with a greater or lesser intensity of fluorescence. This results in the visible greyscale image. However, the term greyscale image is misleading, since the colour of the second text, numeric and/or image data visible in the second zone is dependent on the colour of the light emitted by the fluorescent substance. More precisely, the image is monochromatic. If the depth of the engraving is not varied, the result is merely a light/dark effect (“black/white effect”). This is suitable in particular for the reproduction of text and numeric data, while for image data a monochromatic grey scale representation may be advantageous.

The second text, numeric and/or image data engraved into the second zone may be a copy of or a supplement to at least some of the first text, numeric and/or image data printed onto the substrate. In this case, the copy of the data in the second zone may either have approximately the same dimensions as the data on the substrate or the copy of the data in the second zone may have dimensions which differ from the data on the substrate (larger or smaller).

The second text, numeric and/or image data may be engraved into the layer of the laminating film as a greyscale image using a laser, wherein the layer may be located on the side of the laminating film remote from the substrate or within said laminating film if it is multilayer. The layer may also be located on the side of the laminating film facing the substrate.

Both the substrate and the laminating film thus bear text, numeric and/or image data relevant to the identification document and are laminated into an integral unit.

Further aims, features, advantages and possible applications will become clear from the following description of exemplary embodiments of the identification document, to be understood to be non-limiting, and the associated drawings. All the features of the identification document described and/or illustrated in the Figures, alone or in any desired combination, constitute the identification document disclosed herein, irrespective of how they are grouped in the claims or of the back-references between the claims.

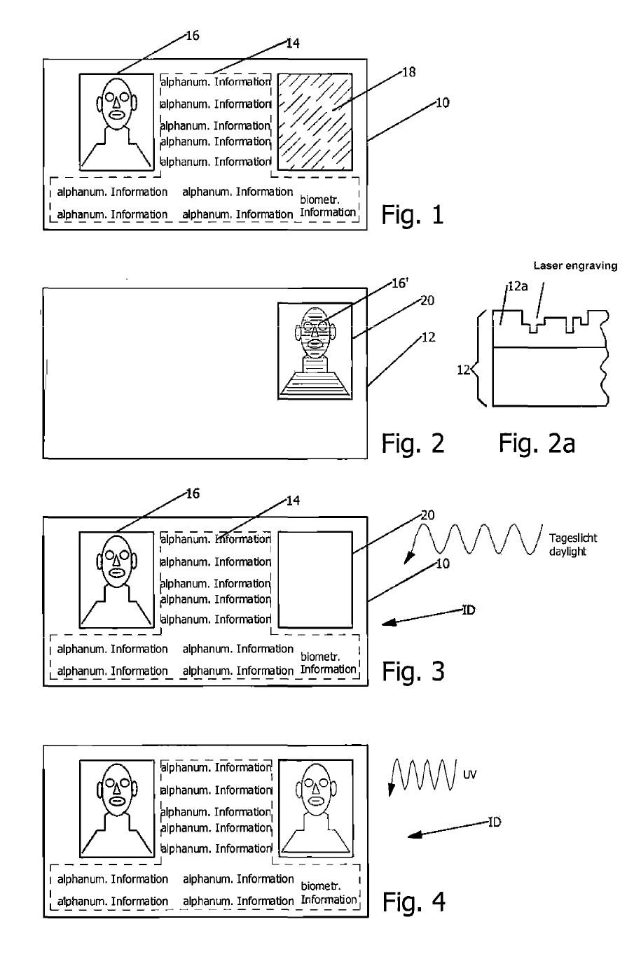

FIG. 1 shows a substrate of an identification document in a schematic planview.

FIG. 2 shows a laminating film of the identification document in a schematic plan view.

FIG. 2a shows the laminating film of the identification document in a greatly enlarged lateral schematic sectional view.

FIG. 3 shows the laminated-together identification document when irradiated with daylight.

FIG. 4 shows the laminated-together identification document when irradiated with UV light.

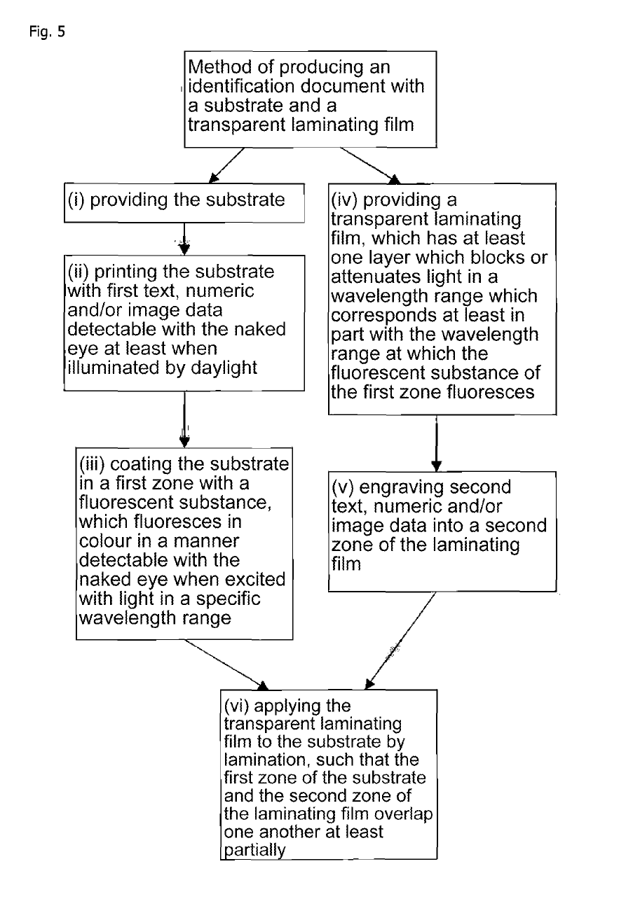

FIG. 5 explains a method of producing an identification document.

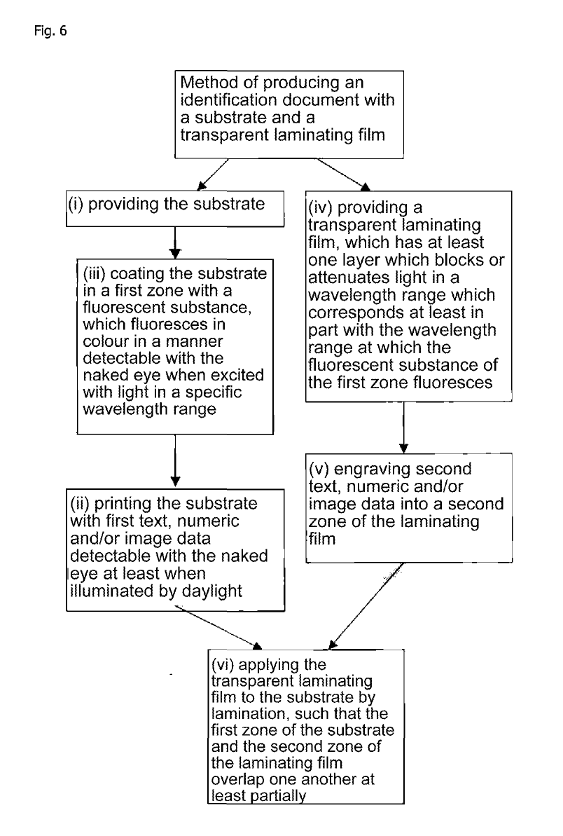

FIGS. 6-8 show further variants of the method of producing an identification document.

### DETAILED DESCRIPTION OF VARIANT EMBODIMENTS

In the drawings the reference sign ID denotes an identification document which has a substrate 10 in the form of an approximately rectangular, substantially flat card and a laminating film 12 bonded to the substrate 10, the area dimensions of which correspond in the present example to those of the substrate but may also differ therefrom (larger or smaller).

The substrate and also the laminating film may contain one or more of the following materials: polyethylene (PE), polyvinyl chloride (PVC), polyethylene terephthalate (PET) or glycol-modified polyethylene terephthalate (PETG), polyethylene naphthalate (PEN), acrylonitrile-butadiene-styrene copolymer (ABS), polyvinyl butyra I (PVB), polymethyl methacrylate (PMMA), polyimide (PI), polyvinyl alcohol (PVA), polystyrene (PS), polyvinylphenol (PVP), polyethylene (PE), polypropylene (PP), polycarbonate (PC) or the derivatives thereof. Metals may also be used as a material for the card (aluminium, steel, noble metals).

The substrate and the laminating film may be bonded together by lamination. Said lamination may involve exposure to heat and/or pressure, which acts on the laminating film and the substrate lying flat against or on one another. Pressure or temperature profiles should be selected which are suitable for the selected materials.

The laminating film may consist of one or more layers, for example a hologram layer, an adhesive layer, a protective layer, etc.. The material of the layers (or the individual layer) and of any additives therein establishes the light-blocking characteristics in specific wavelength ranges. Thus both the complete laminating film and just one or more of the layers thereof may have (UV) light-blocking characteristics. The material of the laminating film is transparent or opaque, may be engraved mechanically or with the assistance of a laser beam and is “(UV) light-blocking”.

If the substrate and the laminating film contain polyethylene (PE), polyethylene terephthalate (PET) or glycol-modified polyethylene terephthalate (PETG) as the material, lamination may be performed for example at temperatures in the range from approx. 70 ° C. to approx. 160 ° C., in particular from approx. 100 ° C. to approx. 130 ° C., preferably at approx. 120 ° C. In the case of polycarbonate (PC) the temperatures may lie for example in the range from approx. 140 ° C. to approx. 260 ° C., or from approx. 180 ° C. to approx. 220 ° C., preferably at approx. 200 ° C.

In the present example both the laminating film 12 and the substrate 10 are made of polyethylene, but other materials/material pairs are also possible.

The surface of the substrate 10 facing the laminating film 12 has first text, numeric 14 and image data 16, which are detectable with the naked eye when illuminated by daylight. Moreover, the surface of the substrate 10 facing the laminating film 12 has a first zone 18 with a fluorescent substance. When excited with light in a specific wavelength range this substance fluoresces in colour in a manner detectable with the naked eye. The first zone 18 with the fluorescent substance is at least virtually invisible relative to its surroundings on the substrate 10 when illuminated by daylight. Ultraviolet light (UV light) has wavelengths of between approx. 100 nm and 400 nm.

An example of a fluorescent substance which may be mentioned is an inkjet printing ink, which is an aqueous liquid (60-80%) with added humectants (5-10%), surface-active substances (0-1%), alcohol (10-20%) and a water-soluble optical brightener (1-3%). This optical brightener is distinguished by excitement in the shortwave range and exhibits remission in the visible range of e.g. green, red or yellow. Examples which may be listed here are the green-fluorescing active substance: excitation: 250-280 nm, remission peaks: 400-500 nm, 540-560 nm, 580-590 nm, or the red fluorescing active substance: excitation: 250-290nm remission peaks: 580-600 nm, 610-620 nm.

Other substances may also be used, however. The above details should be understood as examples; in specific applications the substances and the wavelengths may also deviate therefrom.

To achieve the described effect, a series of materials may be used whose chemical compositions may differ greatly from one another. The respective wavelength range is also variable as a result of the possible use of different materials.

In the present example, the laminating film 12 comprises not only in the second zone 20 but rather over its entire extent a layer 12a which blocks or at least attenuates light in a specific wavelength range. This specific wavelength range corresponds at least partially with the wavelength range in which the fluorescent substance of the first zone 18 fluoresces in colour in a manner detectable with the naked eye.

The laminating film 12 has a second zone 20, which bears second image data 16′.

The second image data 16′ located in the second zone 20 are engraved into the layer 12a of the laminating film 12 which blocks or at least attenuates light in a specific wavelength range merely to such a shallow depth that, when illuminated with daylight, they are at least virtually invisible relative to their surroundings on the surface of the laminating film 12 or indistinguishable from their surroundings. On the other hand these second data are engraved to such a depth into the layer 12a that the second image data 16 are detectable with the naked eye when illuminated with light of a wavelength range which excites the fluorescent substance of the first zone 20 and causes it to fluoresce.

At least in the second zone the laminating film may have a layer which blocks or at least attenuates light in a specific wavelength range. This specific wavelength range may correspond at least partially with the wavelength range in which the fluorescent substance of the first zone fluoresces in colour in a manner detectable with the naked eye.

This layer may also extend over the entire laminating film. In addition, this layer may be applied onto the laminating film or the laminating film has overall the characteristic of blocking or at least attenuating light in a specific wavelength range. An example which may be mentioned of a layer which blocks or at least attenuates light in a specific wavelength range is a security laminate of the type TKO Utopia2 Specimen from OVD Kinegram AG, CH-6301 Zug, Switzerland. The above details should be understood as examples; in specific applications the materials of the layers may also deviate therefrom.

The substrate may have a thickness, for example, of approx. 100 μm to approx. 2000 μm. The laminating film may for example have a thickness of approx. 100 μm to approx. 600 μm, the layer which blocks or at least attenuates light in a specific wavelength range having a thickness of approx. 300 μm. The above-stated dimensions should be understood as examples; in specific applications the dimensions of the individual layers may also deviate therefrom.

The second (image) data located in the second zone may be engraved into the layer of the laminating film which blocks or at least attenuates light in a specific wavelength range merely to such a shallow depth that these data are at least virtually invisible relative to their surroundings on the surface of the laminating film when illuminated with daylight. The depth of engraving may here amount for example to approx. 5% up to approx. 35% of the total thickness of this layer (see FIG. 2a). The above indication should be understood as an example; in specific applications the depth to which the laminating film is engraved may also deviate therefrom.

The first zone 18 of the substrate 10 and the second zone 20 of the laminating film 12 overlap one another completely in the present example.

The second image data 16′ located in the second zone 20 are engraved into the layer 12a of the laminating film 12 as a greyscale image.

The substrate 10 and the laminating film 12 bear text, numeric and/or image data relevant to the identification document and form an integral unit.

To this end the laminating film 12 is laminated onto the substrate 10, such that the first zone 18 of the substrate 10 and the second zone 20 of the laminating film 12 overlap one another at least in part.

The second image data 16′ are engraved into the layer 12a of the laminating film 12 as a greyscale image by means of a laser source. The layer 12a is then located on the side of the laminating film 12 remote from the substrate 12.

FIG. 5 explains a method of producing an identification document. It has the following steps: (i) providing the substrate, (ii) printing the substrate with first text, numeric and/or image data detectable with the naked eye at least when illuminated by daylight, (iii) coating the substrate in a first zone with a fluorescent substance, which fluoresces in colour in a manner detectable with the naked eye when excited with light in a specific wavelength range, (iv) providing a laminating film, (v) engraving second text, numeric and/or image data into a second zone of the laminating film, and (vi) applying the laminating film to the substrate by lamination, such that the first zone of the substrate and the second zone of the laminating film overlap one another at least partially.

In the sequence illustrated in FIG. 5 processing of the substrate and processing of the laminating film are shown as parallel subprocesses, which are then brought together with lamination of the substrate to the laminating film and come to a simultaneous end. However, it is also possible to perform these two subprocesses one after the other.

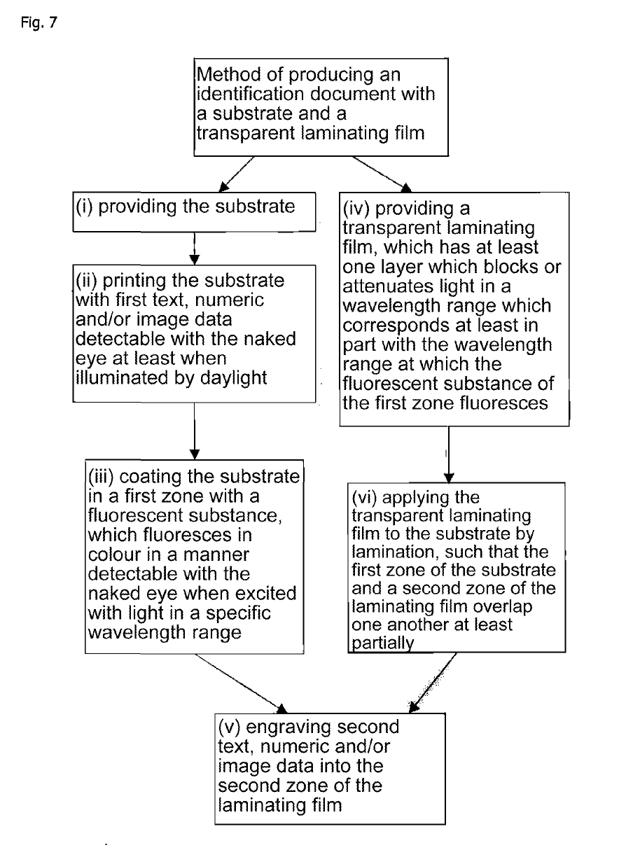

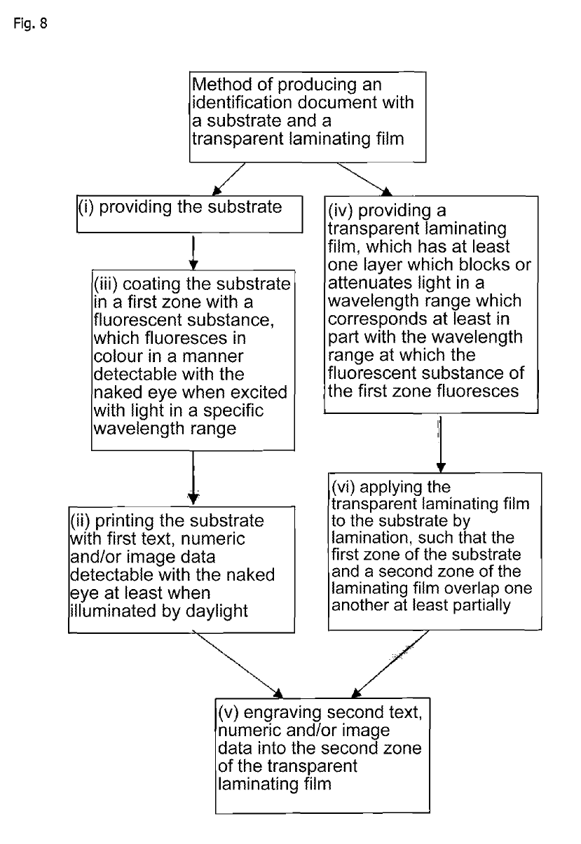

FIGS. 6-8 show further variants of processing of the substrate and processing of the laminating film to produce the identification document. In this respect FIG. 6 shows the order of steps (ii) and (iii) switched round. According to FIG. 7 the order of steps (v) and (vi) has been switched round. In FIG. 8 both the order of steps (ii) and (iii) and the order of steps (v) and (vi) has been switched round.

In a further variant the step (iii) coating the substrate in the first zone with a fluorescent substance, which fluoresces in colour in a manner detectable with the naked eye when excited with light in a specific wavelength range, may also be replaced by embedding a fluorescent substance into the material of the substrate in a first zone when producing the substrate, which fluorescent substance fluoresces in colour in a manner detectable with the naked eye when excited with light in a specific wavelength range. It is also possible for the surface of the substrate to comprise a slight indentation in the first zone, into which the fluorescent substance is introduced such that it ends at least approximately flush with the surface of the substrate. This results in an at least approximately planar substrate surface throughout, the consequence of which is a smoother surface of the finished identification document, such that this security feature is more difficult to detect with the naked eye.

1. An identification document (ID) having:
a substrate; and
a laminating film bonded to the substrate, wherein the surface of the substrate facing the laminating film bears,
first text, numeric and/or image data detectable with the naked eye at least when illuminated by daylight, and
a first zone with a fluorescent substance which fluoresces in colour in a manner detectable with the naked eye when excited with light in a specific wavelength range, and wherein
the laminating film comprises a second zone, which bears second text, numeric and/or image data, wherein the second text, numeric and/or image data located in the second zone are engraved to such a depth into a layer of the laminating film which blocks or at least attenuates light in a specific wavelength range that the blocking or at least attenuating effect of said layer is reduced to such an extent that the second text, numeric and/or image data located in the second zone are detectable with the naked eye when illuminated with light of a wavelength range which excites the fluorescent substance of the first zone and causes it to fluoresce, and wherein
the first zone of the substrate and the second zone of the laminating film overlap one another at least in part.

2. An identification document (ID) according to claim 1, wherein the first zone with the fluorescent substance is at least virtually invisible relative to its surroundings on the substrate when illuminated by daylight.

3. An identification document (ID) according to claim 1, wherein the specific wavelength range of the layer which blocks or at least attenuates light corresponds at least partially with the wavelength range in which the fluorescent substance of the first zone fluoresces in colour in a manner detectable with the naked eye.

4. An identification document (ID) according to claim 1, wherein the second text, numeric and/or image data located in the second zone are engraved into the layer of the laminating film which blocks or at least attenuates light in a specific wavelength range merely to such a shallow depth that, when illuminated with daylight, they are at least virtually invisible relative to their surroundings on the surface of the laminating film.

5. An identification document (ID) according to claim 1, wherein the second text, numeric and/or image data located in the second zone are engraved as a greyscale image into the layer of the laminating film which blocks or at least attenuates light in a specific wavelength range.

6. An identification document (ID) according to claim 1, wherein both the substrate and the laminating film bear text, numeric and/or image data relevant to the identification document and form an integral unit.

7. A method of producing an identification document (ID) with a substrate and a laminating film, having the following steps:
(i) providing the substrate,
(ii) printing the substrate with first text, numeric and/or image data detectable with the naked eye at least when illuminated by daylight,
(iii) coating the substrate in a first zone with a fluorescent substance, which fluoresces in a manner detectable with the naked eye when excited with light of a specific wavelength range,
(iv) providing a laminating film,
(v) engraving second text, numeric and/or image data in a second zone of the laminating film, wherein the engraved text, numeric and/or image data are engraved to such a depth into a layer of the laminating film which blocks or at least attenuates light in a specific wavelength range that the blocking or at least attenuating effect of the layer is reduced to such an extent that the second text, numeric and/or image data located in the second zone are detectable with the naked eye when illuminated with light of a wavelength range which excites the fluorescent substance of the first zone and causes it to fluoresce, and
(vi) applying the laminating film to the substrate by lamination, such that the first zone of the substrate and the second zone of the laminating film overlap one another at least partially.

8. A method of producing an identification document (ID) according to claim 7, wherein the first zone with the fluorescent substance is configured such that it is at least virtually invisible relative to its surroundings on the substrate when illuminated by daylight.

9. A method of producing an identification document (ID) according to claim 7, wherein the specific wavelength range of the layer blocking or at least attenuating light may correspond at least partially with the wavelength range in which the fluorescent substance of the first zone fluoresces in colour in a manner detectable with the naked eye.

10. A method of producing an identification document (ID) according to claim 7, wherein the second text, numeric and/or image data engraved into the second zone are engraved into the layer of the laminating film which blocks or at least attenuates light in a specific wavelength range merely to such a shallow depth that, when illuminated with daylight, they are at least virtually invisible relative to their surroundings on the surface of the laminating film.

11. A method of producing an identification document (ID) according to claim 7, wherein the second text, numeric and/or image data engraved into the second zone are engraved as a greyscale image into the layer of the laminating film which blocks or at least attenuates light in a specific wavelength range.

12. A method of producing an identification document (ID) according to claim 7, wherein the second text, numeric and/or image data engraved into the second zone are a copy of or a supplement to at least some of the first text, numeric and/or image data printed onto the substrate.

13. A method of producing an identification document (ID) according to claim 7, wherein the second text, numeric and/or image data are engraved into the layer of the laminating film as a greyscale image by means of a laser source, wherein the layer is located on the side of the laminating film remote from the substrate.

14. A method of producing an identification document (ID) according to claim 7, wherein both the substrate and the laminating film bear text, numeric and/or image data relevant to the identification document and form an integral unit.

15. A method of producing an identification document (ID) according to claim 7, wherein either:
step ii) printing the substrate with first text, numeric and/or image data detectable with the naked eye at least when illuminated by daylight is carried out prior to step iii) coating the substrate in a first zone with a fluorescent substance, which fluoresces in a manner detectable with the naked eye when excited with light in a specific wavelength range, or
step iii) coating the substrate in a first zone with a fluorescent substance, which fluoresces in a manner detectable with the naked eye when excited with light in a specific wavelength range is carried out prior to step ii) printing the substrate with first text, numeric and/or image data detectable with the naked eye at least when illuminated by daylight.

16. A method of producing an identification document (ID) according to claim 7, wherein either:
step v) engraving second text, numeric and/or image data in a second zone of the laminating film is carried out prior to step vi) applying the laminating film to the substrate by lamination, such that the first zone of the substrate and the second zone of the laminating film overlap one another at least partially, or
step vi) applying the laminating film to the substrate by lamination, such that the first zone of the substrate and the second zone of the laminating film overlap one another at least partially is carried out prior to step v) engraving second text, numeric and/or image data in a second zone of the laminating film.
